(19) United States
(12) Patent Application Publication
(10) Pub. No.: US 2006/0123042 A1
(43) Pub. Date: Jun. 8, 2006

(54) Block importance analysis to enhance browsing of web page search results

(75) Inventors: Xing Xie, Beijing (CN); Wei-Ying Ma, Beijing (CN); Gengxin Miao, Beijing (CN)

Correspondence Address: LEE & HAYES PLLC, 421 W RIVERSIDE AVENUE SUITE 500, SPOKANE, WA, 99201, US

(73) Assignee: Micrsoft Corporation, Redmond, WA (US)

(21) Appl. No.: 11/007,082

(22) Filed: Dec. 7, 2004

(51) Int. Cl. G06F 17/00; G06F 7/00

(52) U.S. Cl. 707/102

(57) ABSTRACT

Systems and methods for block importance analysis to enhance browsing of web page search results are described. In one aspect, a server analyzes content of a document as a function of multiple block importance criteria. The server assigns a respective block importance level of multiple importance levels to respective block(s) of the analyzed content. The server generates one or more customized documents from block(s) of the content as a function of respective assigned block importance level(s) of the block(s). Each of the one or more customized documents is generated in a particular format of multiple formats to enhance user interaction with the document on a small form factor computing device.

### TECHNICAL FIELD

This disclosure relates to network search result formatting and presentation.

### BACKGROUND

Many people search the web using small Internet devices such as handheld computers, phones, etc., when they are on the move. Though conventional search engines can be directly visited from mobile devices with web browsing capabilities, the information is not as conveniently accessible from a handheld device as it is from desktops. Existing information discovery mechanisms for searching the web are not well-suited to the relatively small display footprints associated with most mobile devices. One reason for this is because when screen size is reduced, as it is in most mobile computing devices, end-user searching efficiency drops.

For example, the small form factors of mobile devices make user interaction very inconvenient. Small devices usually do not have a keyboard or a mouse. It is therefore quite difficult to perform complex tasks, such as entering a long paragraph of text. Additionally, because of the small screen size, web browsing is like seeing a mountain in a distance from a telescope. It requires the user to manually scroll the window to find the content of interest and position the window properly for reading information.

Additionally, mobile devices usually have a limited processing power and access the Internet via low speed wireless networks. It typically requires a substantial amount of time to transmit and render the whole web pages in such a scenario. For example, delivery of a homepage over a General Packet Radio Service (GPRS) connection and the successive rendering on a handheld computing device generally takes a substantial amount of time. Consequently, individuals often perform fewer searches and review fewer search result pages on mobile devices than on conventional full form factors computing devices such as on a desktop machine.

### SUMMARY

Systems and methods for block importance analysis to enhance browsing of web page search results are described. In one aspect, a server analyzes content of a document as a function of multiple block importance criteria. The server assigns a respective block importance level of multiple importance levels to respective block(s) of the analyzed content. The server generates one or more customized documents from block(s) of the content as a function of respective assigned block importance level(s) of the block(s). Each of the one or more customized documents is generated in a particular format of multiple formats to enhance user interaction with the document on a small form factor computing device.

### BRIEF DESCRIPTION OF THE DRAWINGS

In the Figures, the left-most digit of a component reference number identifies the particular Figure in which the component first appears.

FIG. 1 illustrates an exemplary system for block importance analysis to enhance browsing of web page search results.

FIG. 2 shows exemplary web page presentation views (thumbnail, optimized single column, and main content views), wherein the web page has been analyzed with respect to block importance criteria.

FIG. 3 shows exemplary aspects of formatted document block importance labeling and block selection.

FIG. 4 shows an optimized view of a formatted document, wherein most important block(s) of content are located at the top of the web page (as indicated by the top position of a thumb-scroll in the corresponding scroll-bar.

FIG. 5 shows an optimized view of a formatted document, wherein least important (least relevant) block(s) of content are located at the bottom of the web page (as indicated by the lower position of thumb-scroll 402 in scroll-bar 404.

FIG. 6 shows an exemplary main content presentation of a formatted document, wherein only main content of the web page is presented to a user.

FIG. 7 shows an exemplary procedure for a server to implement block importance analysis to enhance browsing of web page search results at a client.

FIG. 8 shows an exemplary procedure for a client to request content and a specific content presentation format to a server. The content presented in the presentation format is selected as a function of web page content block importance analysis to enhance browsing of web page search results at the client.

FIG. 9 shows an example of a suitable computing environment in which systems and methods for block importance analysis to enhance browsing of web page search results may be fully or partially implemented.

### DETAILED DESCRIPTION

Overview

Information needs are typically very different for mobile users as compared to desktop users. When a mobile device is used for information search and retrieval, a user's would typically like to receive relevant answers/information to specific queries, rather than receiving a large amount of content that must be closely scrutinized, as they might do on a desktop, to identify relevant answers/information. However, no existing approach to web page adaptation to improve search result presentation has provided an efficient way to indicate to an end-user part(s) of a web page that are more important as compared to other portions of the same web page.

In contrast to such conventional approaches, the systems and methods for utilizing a block importance model to enhance browsing of web image search results do indicate to an end-user part(s) of a web page that are more important as compared to other portions of the same web page. Moreover, the systems and methods present this information, which has objectively been determined to be important to the user's query, in one or more different document formats or presentations of differing levels of detail as a function of user specified interactions. These presentations are designed to substantially reduce both the number of user interactions and the amount of time that an end-user may take to find information of interest within web search results. To theses ends, the systems and methods employ a block importance model to assign importance values to different segments of a web page to extract and present substantially condensed search results to a mobile user in a presentation format selected by the user. The condensed search results do not include non-relevant information like advertisements and navigation bars.

These and other aspects of the systems and methods utilizing a block importance model to enhance browsing of web image search results are now described in greater detail.

An Exemplary System

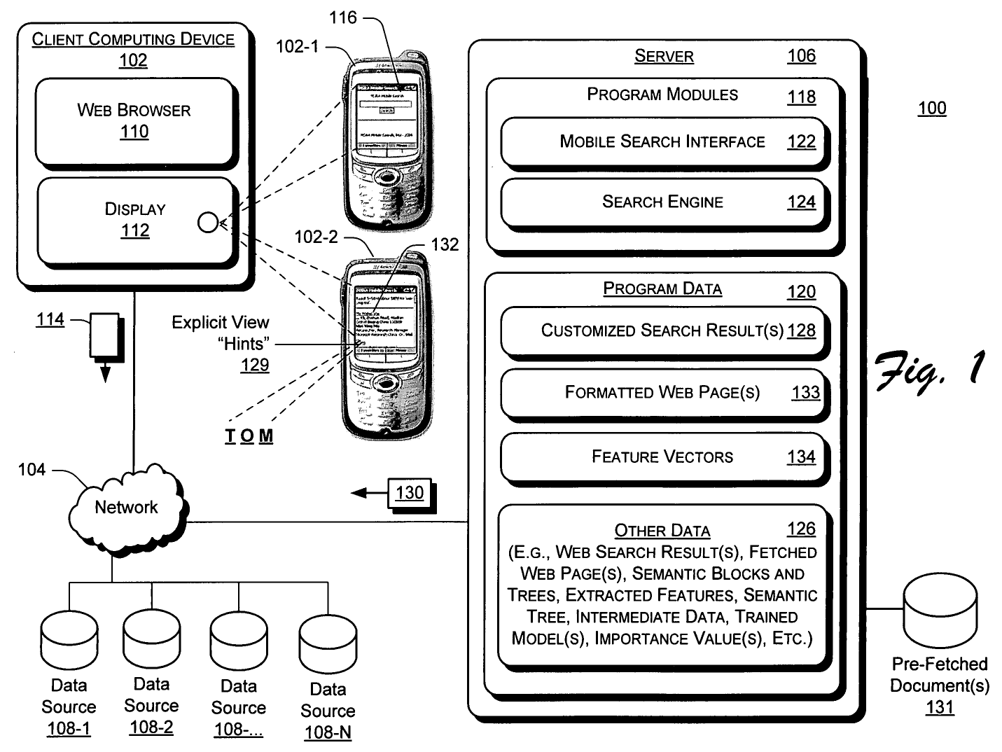

FIG. 1 shows an exemplary system 100 for block importance analysis to enhance browsing of web page search results. In this implementation, system 100 includes client computing device 102 coupled across a communications network 104 to server 106, which in turn is coupled to any number of data repositories 108-1 through 108-N. Network 104 may include any combination of a local area network (LAN) and a general wide area network (WAN) communication environments, such as those which are commonplace in offices, enterprise-wide computer networks, intranets, and the Internet. Client computing device 102 is any type of computing device such as a small form factor mobile computing device (e.g., a cellular phone, personal digital assistant, or handheld computer), personal computer, a laptop, a server, etc. Exemplary such client computing devices 102 are shown as mobile computing devices (phones) 102-1 and 102-2.

Client computing device 102 includes one or more program modules such as web browser 110. Web browser 110 presents a user interface on display 112 such as a small form factor LCD screen or other type of display. The user interface allows a user to format a query 114 from one or more keywords, select a search results for display, and indicate a particular customized document format in which the server 106 is to return the selected search result to the client computing device 102 for display. One aspect of an exemplary such user interface (UI) is shown as a simple start page 116. Start page 116 includes, for example, an input text control and a button control. The text input control allows the user to input one or more keywords to formulate query 114. Selection of the button control on UI 116 by the user causes the computing device 102 to send query 114 to server 106, and thereby trigger a keyword search process.

To this end, server 106 includes program modules 118 and program data 120. The program modules include, for example, mobile search interface 122 and search engine 124. In one implementation, the mobile search interface is implemented using ASP.NET. In this implementation search engine 124 is implemented on a same computing device as mobile search interface 122. In another implementation, search engine 124 is implemented on a different computing device than the mobile search interface 122. The search engine 124 can be any type of search engine such as a search engine deployed by MSN®, Google®, and/or so on.

Mobile search interface 122 receives query 114. Responsive to receiving the query 114, mobile search interface 122 communicates the query to search engine 124. Responsive to receipt of the query, search engine 124 searches or mines data source(s) 108 (108-1 through 108-N) for documents (e.g., web page(s)) associated with the keyword(s) to generate search results. For purposes of illustration, the search results are shown as a respective portion of “other data” 126. In this implementation, the search results are a ranked list of documents (e.g., web page(s)) that search engine 124 determined to be related or relevant to the keyword(s) of query 114.

Mobile search interface 122 modifies the search results to generate customized search results 128. More particularly, mobile search interface 122 adds one or more explicit hints 129 to the search results. Explicit hint(s) 129 are user selectable to allow the user to access mobile search interface 122 functionality to specify a particular document format within which the server is to present content of a user selected document, wherein the content has been objectively determined by the mobile search interface to be relevant to the query 114, and wherein the particular document format is substantially optimized for presentation on a small form factor display, such as display 112.

In this implementation, explicit hints 129 are presented with annotations allowing the user to specify: (a) a thumbnail (“T”) view (with annotation) of the selected document; (b) an optimized (“O”) one-column view of the selected document; and/or (c) a main content (“M”) view of the selected document. By selecting one of these explicit hints, the user indicates that content with certain associated level(s) of importance are to be returned to the client computing device 102 for display to the user, and specifies that the content is to be returned in a document format that is associated with the selected explicit hint. Thus, the user is allowed to indicate those portion(s) of a document (e.g., web page) that the user believes is/are most significant. This improves search efficiency for the user.

In this implementation, customized search results 128 include enough information to allow a user to evaluate the listed items, select a relevant link associated with a document of interest, and select an explicit hint 129 for formatting the document of interest.

Mobile search interface 122 communicates customized search results 128 to client computing device 102 in response 130. Responsive to receipt of response 130, browser 110 presents customized search results 128 to a user, for example, by displaying the ranked list with the explicit hints 129 in a user interface. An exemplary presentation of the customized search results 128 with explicit hints 129 is shown on client computing device 102-2 as user interface 132. Responsive to user selection of a link from the ranked list, web browser 110 packages the link and selected explicit hint 129 into request 114 for communication to server 106, and thereby, to mobile search interface 122.

Responsive to receipt of request 114, if the document specified in the request has not already been retrieved by pre-fetch or crawling operations, mobile search interface 122 fetches the specified document from the associated data source 108. For purposes of illustration, fetched document(s) are shown as a respective portion of “other data” 126. Alternatively, if the particular document has already been retrieved, for example, as a result of server 102 crawling or pre-fetching operations, the particular document is retrieved from the pre-fetch location such as from a database 131 that stores pre-fetched (crawled) document(s) such as web page(s). Mobile search interface 122 adapts the fetched document's content as a function of the particular explicit hint (T, O, or M) 129 selected by the user and block importance analysis of the content of the document.

To this end, mobile search interface 122 implements a vision-based page segmentation algorithm to partition the fetched web page into semantic blocks. Semantic blocks are shown as a respective portion of “other data” 126. Such a vision-based algorithm is described in great detail in “VIPS: A vision-based page segmentation algorithm. Microsoft Technical Report”, D. Cai, S. Yu, J. R. Wen, and W. Y. Ma., MSR-TR-2003-70, November 2003, which is hereby incorporated by reference. VIPS makes full use of page layout features such as font, color and size. Next, mobile search interface 122 extracts spatial features and content features are extracted to construct a feature vector 134 for each block. Semantic blocks are shown as a respective portion of “other data” 126. An exemplary set of features that are extracted from the semantic blocks for subsequent block importance evaluations are shown in TABLE 1.

TABLE 1
EXEMPLARY FEATURES FOR EXTRACTION AND BLOCK
IMPORTANCE EVALUATION

| Feature class | Feature name | Description |
|---|---|---|
| absolute spatial | BlockCenterX | Coordinates of the center |
| features | BlockCenterY | of a block |
| | BlockRectWidth | Width and height of a |
| | BlockRectHeight | block |
| relative spatial | BlockCenterX/PageWidth | Using the width and |
| features | BlockCenterY/PageHeight | height of the whole page |
| | BlockRectWidth/PageWidth | to normalize the absolute |
| | BlockRectHeight/PageHeight | spatial features |
| window spatial | Block WindowRectHeight | Using a fixed-height |
| features | Block WindowCenterY | window to normalize the |
| | | absolute spatial features |
| content features | ImgNum | Number and size of |
| | ImgSize | images contained in a |
| | | block |
| | LinkNum | Number of hyperlinks |
| | LinkTextLength | and anchor text length of |
| | | a block |
| | InnerTextLength | Length of text between |
| | | the start and end tags of |
| | | HTML objects |
| | InteractionNum | Number and size of |
| | InteractionSize | elements with <INPUT> |
| | | and <SELECT> tags |
| | FormNum | Number and size of |
| | FormSize | elements with the tag |
| | | <FORM> |

Mobile search interface 122 first extracts all the suitable nodes from the HTML DOM tree, and then finds the separators between these nodes. DTML DOM is the document object model for HTML, which defines a standard set of objects for HTML, and a standard way to access and manipulate HTML objects. In this implementation, separators denote the horizontal or vertical lines in a fetched web page that visually do not cross any node. Based on these separators, a semantic tree of the web page is constructed. Mobile search interface 122 assigns a degree of coherence (DOC) value to each node in the tree to indicate a level of coherency for the node. Coherence represents consistency of content in a HTML node. For example, a coherency measurement indicates whether a node includes very different types of content (e.g., image, tables, and/or so on). An node with high coherency includes a greater amount of similar content as compared to a node of low coherency, which includes greater diversity of content. Mobile search interface 122 utilizes coherency measurement(s) to control the granularity of web page splitting or partitioning.

The semantic tree is shown as a respective portion of “other data” 126. Consequently, mobile search interface 122 efficiently groups related content into blocks of the semantic tree, while separating semantically different content blocks with respect to one another. Each node of the semantic tree corresponds to a respective feature vector.

Each semantic block includes some number of spatial features and some number of content features. In this implementation, each semantic block includes ten (10) spatial features and nine (9) content features, as summarized above in Table 2.

Based on these extracted features, server 106 implements one or more learning algorithms, such as those provided by a Support Vector Machine (SVM) with a Radical Basis Function (RBF) kernel, to train a model that is used by mobile search interface 122 to assign importance values to different semantic blocks of the web page. Mobile search interface 122 recognizes a number of different content importance levels or categories during document block importance analysis operations. In this implementation, objectively determined blocks of content of a document are classified or divided into three independent importance levels, as shown in TABLE 1.

TABLE 2
EXEMPLARY BLOCK IMPORTANCE LEVELS / CATEGORIES

| Level | Description |
|---|---|
| 3 | The most prominent part of a page, such as headlines, main |
| | content, etc. |
| 2 | Useful information, but not very relevant to the topic of a page, |
| | such as navigation, directory, etc.; or relevant information to the |
| | theme of a page, but not with prominent importance, such as |
| | related topics, topic index, etc. |
| 1 | Noisy information such as ads, copyright, decoration, etc. |

The block importance model implemented by mobile search interface 122 is defined as a function to map features to importance of a page block, and is formalized as: <block features>→block importance (1). After splitting a web page P and calculating the importance for each page segment, mobile search interface 122 is left with a set of semantic blocks Bi and corresponding importance values IMPi: P={(Bi, IMPi)} (2). To fit the formatted document 133 into small screens, one or more different approaches are adopted.

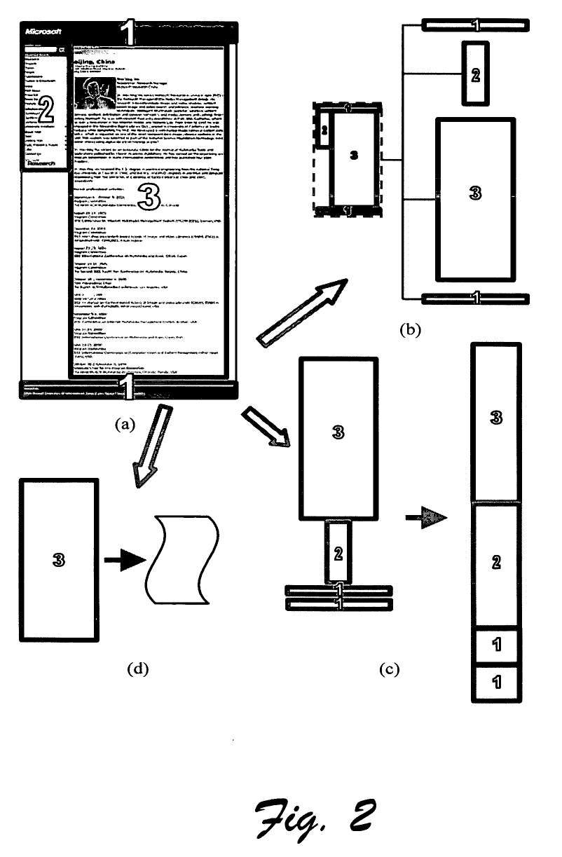

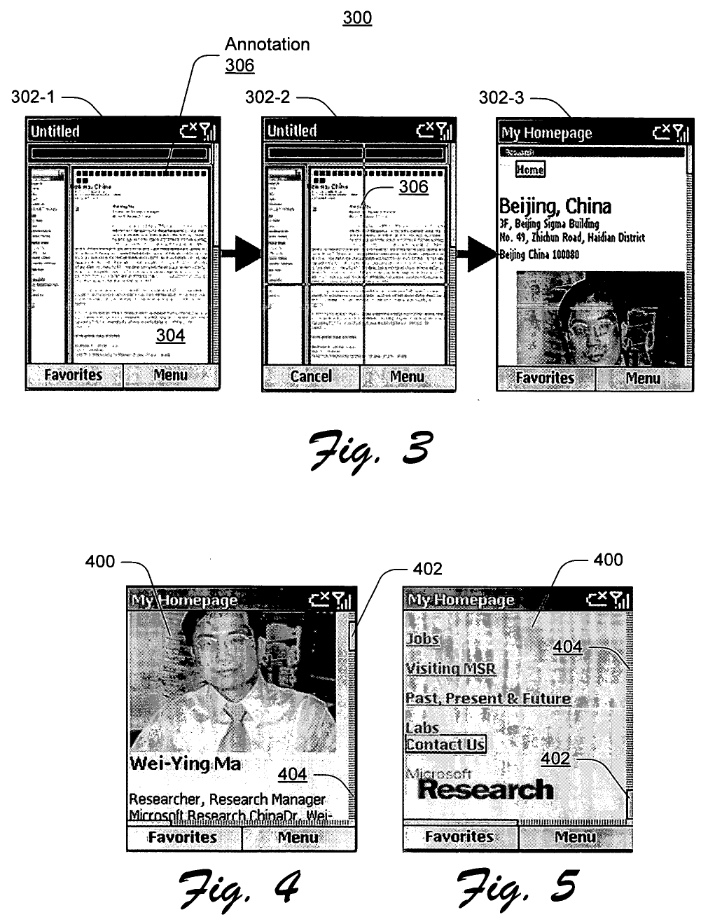

FIGS. 2 and 3 show exemplary aspects of fetched web page (document) block importance labeling results, presentation views, and block selection. Aspects of FIGS. 2 and 3 are described with respect to components of FIG. 1. Whenever an aspect or component from FIG. 1, 2, or 3 is indicated, the left-most digit of the component's reference number identifies the particular figure in which the component first appears. Referring to FIG. 2, portion (a) shows formatted document 133 segmented into three (3) respective semantic blocks with respective levels of importance 1, 2, and 3. As indicated above, and in this implementation: level 1 importance represents noisy information such as ads, copyright, decoration, etc; level 2 importance represents useful information, but not very relevant to the topic of a page, such as navigation, directory, etc.; or relevant information to the theme of a page, but not with prominent importance, such as related topics, topic index, etc; and, level 3 importance represents what has been determined by mobile search interface 122 to be the most substantially prominent or substantive part of a page, such as headlines, main content, etc.

### Exemplary Thumbnail View with Annotation(s)

Portion (b) of FIG. 2 represents a thumbnail view corresponding to a user selected explicit hint of “T” from the ranked list of search results described above. The thumbnail view of the original web page is presented to users to give a global view and index to a set of sub-pages containing the information of different segments—original fetched web page layout is preserved. To generate this view, mobile search interface 122 down sub-samples the fetched web page (document) to generate a thumbnail (formatted document 133) to fit the screen width of display 112, while preserving the page's original two-dimensional layout. In this implementation, when a user selects any portion of the thumbnail associated with a particular importance level, the user may browse the content of that importance block independently of content from any other importance block. In this implementation, corresponding block/content importance indication(s) are annotated on the thumbnail to assist the user to quickly locate relevant content. These aspects are new described with reference to FIG. 3.

FIG. 3 shows exemplary thumbnail views 300 with annotation (302-1), block selection aspects (302-2), and content browsing of a selected block (302-3). Referring to windows 302-1 through 302-3, respective importance values associated with respective ones of different blocks in the web page 102 are marked on the thumbnail using rectangles of different colors, such as red (302-1 and 302-2), green (302-3), and blue (not represented) to respectively represent blocks of importance level 3, level 2, and level 1. In one implementation, the number of occurrences of keyword(s) in a query 114 in each block is annotated with small squares. In this example, the most important semantic block also contains the most query terms, but it may not be the case generally. Therefore, two types of information is shown, the general block importance and the relevance of content in each block to the query terms.

In one implementation, a user utilizes a stylus or logical or physical direction buttons to select an appropriate tile (semantic block) for browsing, as shown with selection crosshair 306. Browser 110 presents content of a selected block to the user as shown in 302-3.

### Exemplary Optimized One-Column View

To avoid horizontal scrolling, many commercial web browsers re-format a web page into a single column to make the page fit the screen width of a small form factor display. While one-column views can facilitate the reading process, conventional techniques to generate such a view typically result in the user having to perform a large amount of vertical scrolling. For example, to access main content using such a view for many web pages, the user is required to scroll past the entire content of the title, advertisements and navigation bar.

This limitation of conventional systems is addressed by the optimized view provided by system 100 (FIG. 1). When a user clicks on a link labeled by “O” (e.g., see FIG. 1, Explicit Hints 129), the optimized one-column view (formatted document 133) is generated by mobile search interface 122. The blocks are sorted according to: Pnew={(Bπ[i], IMPπ[i])|IMPπ[i]>=IMPπ[i+1]} (3). The term Pnew represents a generated page; Bi represents the ith block in the original page; IMPi is the importance of Bi, and π is a sorting of original blocks. The formula ensures, after sorting, that the blocks are arranged in a descending order of importance. The one-column view is communicated to browser 110 for display to the user in a linear pattern. The optimized one-column view has semantic blocks of content sorted in descending order of importance. Portion (c) of FIG. 2 shows an exemplary such optimized one-column view with importance-based blocks of the formatted document 133 sorted in a descending order of importance.

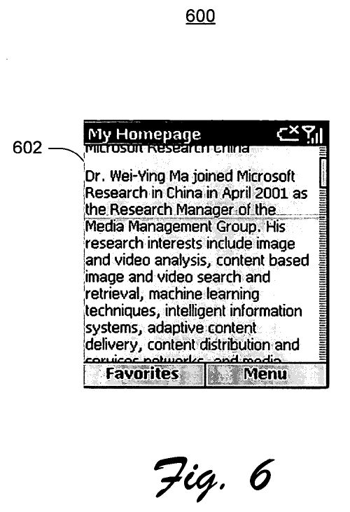

FIG. 4 shows an optimized view 400 of a formatted document, wherein most important block(s) of content are located at the top of the web page (as indicated by the top position of thumb-scroll 402 in scroll-bar 404. FIG. 5 shows an optimized view 400 of a formatted document, wherein least important (least relevant) block(s) of content are located at the bottom of the web page (as indicated by the lower position of thumb-scroll 402 in scroll-bar 404. Using such an optimized web page layout, a user can search the presented content for efficiently for relevant information.

In one implementation, to avoid deleting original web page layout data that could make some content unreadable, such as maps or timetables, the mobile search interface 122 detects and preserves layout of such types of content objects.

### Exemplary Main Convent View

FIG. 6 shows exemplary main content of a formatted document presented in a window 600, wherein only main content of the document (web page) is presented to a user. In the main content view, mobile search interface 122 extracts text from the most important blocks in a fetched web page to generate formatted document 133. Only this main content is displayed to a user as shown in portion (d) of FIG. 2 and FIG. 6. Both of these figures show only importance-based blocks of the formatted document 133 that are determined to be of highest importance level. To this end, mobile search interface 122 generates formatted document 133 according to the user selected explicit hint of “Main”, or “M”, according to Pnew={(Bi, IMPi)|IMPi=3} (4). Use of the main content view may significantly reduce downloading and rendering time while at the same time presenting a sufficient amount of material to address a users' query.

### Exemplary Comparison of the Three Presentation Schemes

TABLE 3 shows an exemplary comparison of the thumbnail, optimized on-column view, and main content presentation schemes.

TABLE 3
EXEMPLARY COMPARISON OF PRESNTATION SCHEMES

| | | Downloading/ | |
|---|---|---|---|
| | Number of | rendering | Information |
| | interactions | time | preserving |
| Thumbnail view with | +++ | +++ | +++ |
| annotation | | | |
| Optimized one-column | ++ | ++ | ++ |
| view | | | |
| Main content view | + | + | + |

Exemplary Procedures

FIG. 7 shows an exemplary procedure 700 for a server to implement block importance analysis to enhance browsing of web page search results at a client. The operations of this procedure are described with respect to aspects of FIG. 1. The left-most digit of a component reference number identifies the particular figure in which the component first appears.

At block 702, mobile search interface 122 (FIG. 1) analyzes content of a document as a function of multiple block importance criteria. In one implementation, the operations of block 702 are performed in demand responsive to receipt of a request 114 from a client computing device 102. In another implementation, the particular web page of interest was pre-fetched, for example, as a result of web crawling operations. The request specifies the document (e.g., web page) of interest. The particular web page of interest was selected by a user of the client computing device from a customized set of search results 128 such as a ranked list of links associated with one or more keywords in a query 114 submitted to search engine 124 in a previous session.

The request 114 associated with the operations of block 702, also includes an explicit hint 129 indicating how the user would like to see content from the selected document formatted by the server 106 before it is returned to the client computing device for presentation to the user. In this implementation, the explicit hint 129 indicates that the user would like to receive the content associated with the web page of interest in a thumbnail (T″), optimized one-column (“O”), or main content (“M”) view—the content of each view being determined as a function of block importance analysis of the associated document's content.

At block 704, mobile search interface 122 assigns a relative block importance level to respective blocks of the document's content. At block 706, mobile search interface 122 generates one or more customized documents 133 from blocks of the fetched document's content as a function of assigned block values and a document format that corresponds to the explicit hint 129 provided by the user. A customized document may be generated upon demand or may be generated in advance of a request for the particular document and document format. At block 708, and responsive to a request identifying a document of interest and a user selected document format (i.e., an explicit hint 129), mobile search interface 122 communicates the document 133 in the requested format to the requesting client computing device 102 for presentation to a user.

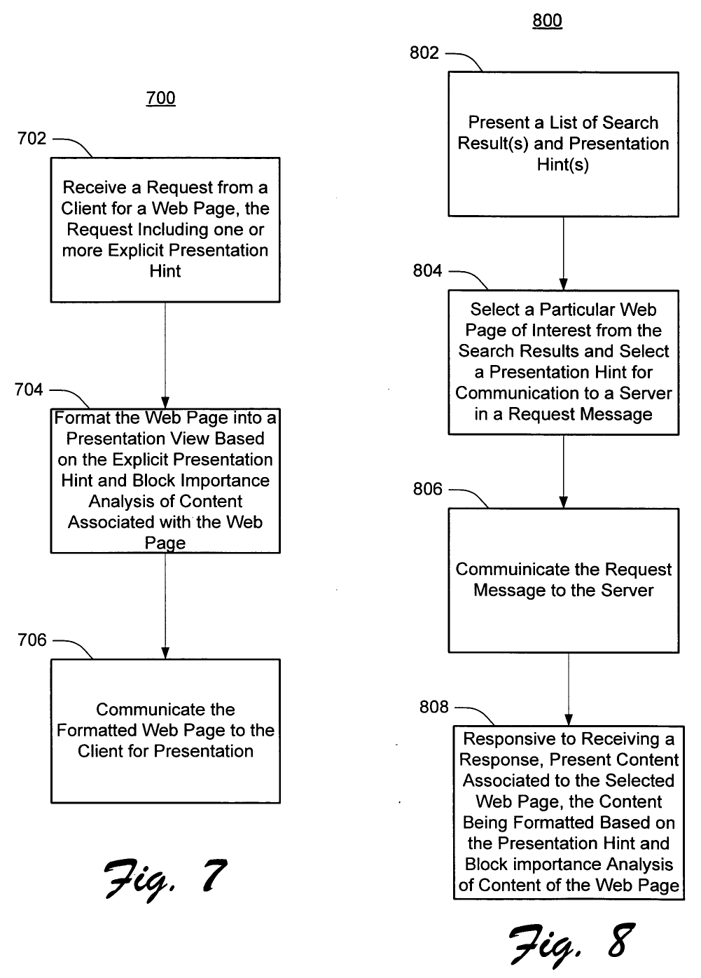

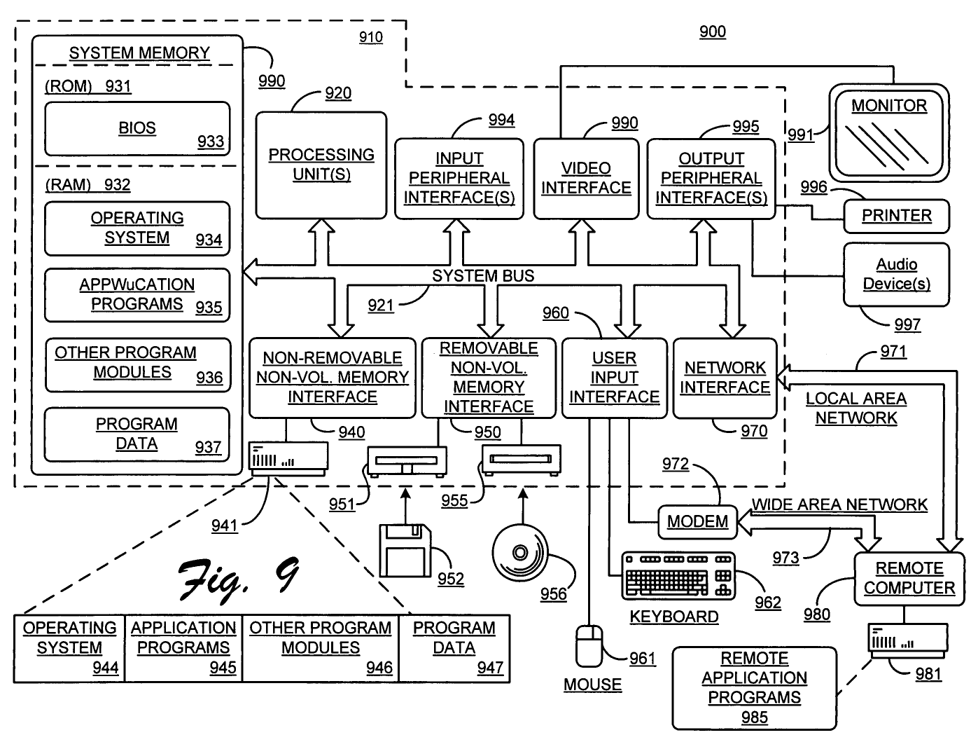

FIG. 8 shows an exemplary procedure 800 for a client to request content and a specific content presentation format to a server. The content presented in the presentation format is selected as a function of web page content block importance analysis to enhance browsing of web page search results at the client. The operations of this procedure are described with respect to aspects of FIG. 1. The left-most digit of a component reference number identifies the particular figure in which the component first appears. At block 802, an application such as a browser 110 executing on the client computing device 102 presents customized search results 128 to a user. The customized search results 128 was communicated to the client responsive to a previous search query 114 from the client to the server 106, wherein the query 114 specified one or more keywords. The server, responsive to receipt of the search query, generated the customized search results 128 from search results corresponding to the query 114. The customized search results 128 include one or more explicit hints for formatting a document identified in the search results as a function of block importance analysis.

At block 804, a user selects a particular link (e.g., hypertext link) of interest, wherein the link corresponds to a document or web page. The user also selects a presentation format (explicit hint 129) indicating how the user would like mobile search interface 122 to format the document or web page before returning it to the client computing device 102 for subsequent presentation to the user. The particular presentations will be generated by the server 106 as a function of the presentation hint selected by the user and as a function of block importance analysis of content associated with the web page of interest. At block 806, the client communicates a request 118 to the server; the request indicates the web page of interest and the desired presentation format (e.g., thumbnail, optimized one-column, or main content view).

At block 808, the client receives a response from the mobile search interface 122, wherein the response includes content associated with the web page of interest, and wherein the content is formatted as a function of the presentation hint selected by the user and as a function of block importance analysis of content associated with the web page of interest—the analysis having been performed at the server by the mobile search interface. Operations of block 808 also present the content (i.e., formatted document 133) to the user.

An Exemplary Operating Environment

Although not required, the systems and methods for block importance analysis to enhance browsing of web page search results have been described in the general context of computer-executable instructions (program modules) being executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

FIG. 9 shows an example of a suitable computing environment in which systems and methods for block importance analysis to enhance browsing of web page search results may be fully or partially implemented. Exemplary computing environment 900 is only one example of a suitable computing environment for the exemplary system of FIG. 1 and exemplary operations of FIGS. 7 and 8, and is not intended to suggest any limitation as to the scope of use or functionality of systems and methods the described herein. Neither should computing environment 900 be interpreted as having any dependency or requirement relating to any one or combination of components illustrated in computing environment 900.

The methods and systems described herein are operational with numerous other general purpose or special purpose computing system, environments or configurations. Examples of well-known computing systems, environments, and/or configurations that may be suitable for use include, but are not limited to, mobile computing devices such as mobile phones and personal digital assistants, personal computers, server computers, multiprocessor systems, microprocessor-based systems, network PCs, minicomputers, mainframe computers, distributed computing environments that include any of the above systems or devices, and so on. The invention is practiced in a distributed computing environment where tasks are performed by remote processing devices that are linked through a communications network. In a distributed computing environment, program modules may be located in both local and remote memory storage devices.

With reference to FIG. 9, an exemplary system for block importance analysis to enhance browsing of web page search results includes a general purpose computing device in the form of a computer 910 implementing, for example, server 106 of FIG. 1. Components of computer 910 may include, but are not limited to, processing unit(s) 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

A computer 910 typically includes a variety of computer-readable media. Computer-readable media can be any available media that can be accessed by computer 910 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or a direct-wired connection, and wireless media such as acoustic, RF, infrared and other wireless media. Combinations of the any of the above should also be included within the scope of computer-readable media.

System memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example and not limitation, FIG. 9 illustrates operating system 934, application programs 935, other program modules 936, and program data 938.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer-readable instructions, data structures, program modules and other data for the computer 910. In FIG. 9, for example, hard disk drive 941 is illustrated as storing operating system 944, application programs 945, other program modules 946, and program data 948. Note that these components can either be the same as or different from operating system 934, application programs 935, other program modules 936, and program data 938. Application programs 935 includes, for example program module(s) 118 of FIG. 1. Program data 938 includes, for example, program data 120 of FIG. 1. Operating system 944, application programs 945, other program modules 946, and program data 948 are given different numbers here to illustrate that they are at least different copies.

A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus 921, but may be connected by other interface and bus structures, such as a parallel port, game port or a universal serial bus (USB).

A monitor 991 or other type of display device is also connected to the system bus 921 via an interface, such as a video interface 990. In addition to the monitor, computers may also include other peripheral output devices such as speakers 998 and printer 996, which may be connected through an output peripheral interface 995.

The computer 910 operates in a networked environment using logical connections to one or more remote computers, such as a remote computer 980. In one implementation, remote computer 950 represents client computing device 102 of FIG. 1. The remote computer 980 may be a mobile computing device, a personal computer, a server, a router, a network PC, a peer device or other common network node, and as a function of its particular implementation, may include many or all of the elements described above relative to the client computing device 102, although only a memory storage device 981 has been illustrated in FIG. 9. The logical connections depicted in FIG. 9 include a local area network (LAN) 981 and a wide area network (WAN) 983, but may also include other networks. Such networking environments are commonplace in offices, enterprise-wide computer networks, intranets and the Internet.

When used in a LAN networking environment, the computer 910 is connected to the LAN 981 through a network interface or adapter 980. When used in a WAN networking environment, the computer 910 typically includes a modem 982 or other means for establishing communications over the WAN 983, such as the Internet. The modem 982, which may be internal or external, may be connected to the system bus 921 via the user input interface 960, or other appropriate mechanism. In a networked environment, program modules depicted relative to the computer 910, or portions thereof, may be stored in the remote memory storage device. By way of example and not limitation, FIG. 9 illustrates remote application programs 985 as residing on memory device 981. The network connections shown are exemplary and other means of establishing a communications link between the computers may be used.

Conclusion

Although the systems and methods for block importance analysis to enhance browsing of web page search results have been described in language specific to structural features and/or methodological operations or actions, it is understood that the implementations defined in the appended claims are not necessarily limited to the specific features or actions described. Rather, the specific features and operations are disclosed as exemplary forms of implementing the claimed subject matter.

1. A method comprising:
analyzing, by a server, content of a document as a function of multiple block importance criteria;
responsive to the analyzing, assigning a respective block importance level of multiple importance levels to respective block(s) of the content; and
generating one or more customized documents from block(s) of the content as a function of respective assigned block importance level(s) of the block(s), each of the one or more customized documents being generated in a particular format of multiple formats to enhance user interaction with the document on a small form factor computing device.

2. A method as recited in claim 1, wherein the document is a web page.

3. A method as recited in claim 1, wherein the block importance criteria identify a most prominent part of the document.

4. A method as recited in claim 3, wherein the most prominent part is a headline or main content corresponding to a topic of the document.

5. A method as recited in claim 1, wherein the block importance criteria identify information not relevant to a topic of the document.

6. A method as recited in claim 5, wherein the information comprises document navigation or directory information.

7. A method as recited in claim 5, wherein the information comprises information relevant to a theme of the document such as a related topic or topic index.

8. A method as recited in claim 1, wherein the block importance criteria identify noisy information including an advertisement, a copyright indication, or a decoration.

9. A method as recited in claim 1, wherein the multiple importance levels comprise a first, second, and third importance level, content associate with the first level being of lesser importance than content associated with the second or the third level, content associate with the second level being less important than content associated with the third level.

10. A method as recited in claim 1, wherein the multiple formats comprise a thumbnail view, an optimized one-column view, and a main content view.

11. A method as recited in claim 1, wherein the particular format is specified by a user and communicated in a request message to the server by a client computing device.

12. A method as recited in claim 1, wherein analyzing is performed responsive to receiving a request from a client computing device to fetch the document, the document being selected by the user from an annotated list of search results, the annotated list comprising one or more explicit hints for selection by the user to indicate the particular format.

13. A method as recited in claim 1, wherein analyzing is performed prior to receiving a request from a client computing device to fetch the document, the document being selected by the user from an annotated list of search results, the annotated list comprising one or more explicit hints for selection by the user to indicate the particular format.

14. A method as recited in claim 1, wherein analyzing further comprises:
partitioning the document into multiple semantic blocks;
for each semantic block of the semantic blocks, extracting spatial features and content features;
for each semantic block of the semantic blocks, generating a respective feature vector from respective spatial and content features;
creating a semantic tree of the document from respective feature vectors generated from the semantic blocks, the semantic tree grouping related content in respective blocks of the multiple semantic blocks; and
and assigning a respective degree of coherence to node(s) of the semantic tree.

15. A method as recited in claim 14, wherein the spatial or content features comprise a location, a personal profile, a time of day, a schedule, or a browsing history.

16. A method as recited in claim 14, wherein the partitioning is implemented with a vision-based page segmentation algorithm.

17. A method as recited in claim 1, wherein assigning further comprises training a model to map block features to respective ones of the multiple importance values.

18. A method as recited in claim 1, further comprising:
receiving search results from a search engine, the search results comprising a link associated with the document;
annotating the search results with one or more explicit hints for selection by a user to indicate any one format of the multiple formats, each format of the formats indicating a respective page layout for the one or more customized documents, portion(s) of the content being inserted or left out of the respective layout as a function block importance level(s) associated with the portion(s); and
communicating the annotated search results to a target client computing device.

19. A computer-readable medium comprising computer-program instructions executable by a processor for:
analyzing, by a server, content of a document as a function of multiple block importance criteria;
responsive to the analyzing, assigning a respective block importance level of multiple importance levels to respective block(s) of the content; and
generating one or more customized documents from block(s) of the content as a function of respective assigned block importance level(s) of the block(s), each of the one or more customized documents being generated in a particular format of multiple formats to enhance user interaction with the document on a small form factor computing device.

20. A computer-readable medium as recited in claim 19, wherein the document is a web page.

21. A computer-readable medium as recited in claim 19, wherein the block importance criteria identify a most prominent part of the document.

22. A computer-readable medium as recited in claim 21, wherein the most prominent part is a headline or main content corresponding to a topic of the document.

23. A computer-readable medium as recited in claim 19, wherein the block importance criteria identify information not relevant to a topic of the document.

24. A computer-readable medium as recited in claim 23, wherein the information comprises document navigation or directory information.

25. A computer-readable medium as recited in claim 23, wherein the information comprises information relevant to a theme of the document such as a related topic or topic index.

26. A computer-readable medium as recited in claim 19, wherein the block importance criteria identify noisy information including an advertisement, a copyright indication, or a decoration.

27. A computer-readable medium as recited in claim 19, wherein the multiple importance levels comprise a first, second, and third importance level, content associate with the first level being of lesser importance than content associated with the second or the third level, content associate with the second level being less important than content associated with the third level.

28. A computer-readable medium as recited in claim 19, wherein the multiple formats comprise a thumbnail view, an optimized one-column view, and a main content view.

29. A computer-readable medium as recited in claim 19, wherein the particular format is specified by a user and communicated in a request message to the server by a client computing device

30. A computer-readable medium as recited in claim 19, wherein the computer-program instructions for analyzing are performed responsive to receiving a request from the client computing device to fetch the document, the document being selected by the user from an annotated list of search results, the annotated list comprising one or more explicit hints for selection by the user to indicate the particular format.

31. A computer-readable medium as recited in claim 19, wherein the computer-program instructions for analyzing are prior to receiving a request from a client computing device to fetch the document, the document being selected by the user from an annotated list of search results, the annotated list comprising one or more explicit hints for selection by the user to indicate the particular format.

32. A computer-readable medium as recited in claim 19, wherein the computer-program instructions for analyzing further comprise instructions for:
partitioning the document into multiple semantic blocks;
for each semantic block of the semantic blocks, extracting spatial features and content features;
for each semantic block of the semantic blocks, generating a respective feature vector from respective spatial and content features;
creating a semantic tree of the document from respective feature vectors generated from the semantic blocks, the semantic tree grouping related content in respective blocks of the multiple semantic blocks; and
and assigning a respective degree of coherence to node(s) of the semantic tree.

33. A computer-readable medium as recited in claim 32, wherein the spatial or content features comprise a location, a personal profile, a time of day, a schedule, or a browsing history.

34. A computer-readable medium as recited in claim 32, wherein the computer-program instructions for partitioning are implemented with a vision-based page segmentation algorithm.

35. A computer-readable medium as recited in claim 19, wherein the computer-program instructions for analyzing further comprise instructions for training a model to map block features to respective ones of the multiple importance values.

36. A computer-readable medium as recited in claim 19, wherein the computer-program instructions further comprise instructions for:
receiving search results from a search engine, the search results comprising a link associated with the document;
annotating the search results with one or more explicit hints for selection by a user to indicate any one format of the multiple formats, each format of the formats indicating a respective page layout for the one or more customized documents, portion(s) of the content being inserted or left out of the respective layout as a function block importance level(s) associated with the portion(s); and
communicating the annotated search results to a target client computing device.

37. A computing device comprising:
a processor; and
a memory coupled to the processor, the memory comprising computer-program instructions executable by the processor for:
analyzing, by a server, content of a document as a function of multiple block importance criteria;
responsive to the analyzing, assigning a respective block importance level of multiple importance levels to respective block(s) of the content; and
generating one or more customized documents from block(s) of the content as a function of respective assigned block importance level(s) of the block(s), each of the one or more customized documents being generated in a particular format of multiple formats to enhance user interaction with the document on a small form factor computing device.

38. A computing device as recited in claim 37, wherein the document is a web page.

39. A computing device as recited in claim 37, wherein the block importance criteria identify a most prominent part of the document.

40. A computer-readable medium as recited in claim 21, wherein the most prominent part is a headline or main content corresponding to a topic of the document.

41. A computing device as recited in claim 37, wherein the block importance criteria identify information not relevant to a topic of the document.

42. A computing device as recited in claim 41, wherein the information comprises document navigation or directory information.

43. A computing device as recited in claim 41, wherein the information comprises information relevant to a theme of the document such as a related topic or topic index.

44. A computing device as recited in claim 37, wherein the block importance criteria identify noisy information including an advertisement, a copyright indication, or a decoration.

45. A computing device as recited in claim 37, wherein the multiple importance levels comprise a first, second, and third importance level, content associate with the first level being of lesser importance than content associated with the second or the third level, content associate with the second level being less important than content associated with the third level.

46. A computing device as recited in claim 37, wherein the multiple formats comprise a thumbnail view, an optimized one-column view, and a main content view.

47. A computing device as recited in claim 37, wherein the particular format is specified by a user and communicated in a request message to the server by a client computing device.

48. A computing device as recited in claim 37, wherein the computer-program instructions for analyzing are performed responsive to receiving a request from the client computing device to fetch the document, the document being selected by the user from an annotated list of search results, the annotated list comprising one or more explicit hints for selection by the user to indicate the particular format.

49. A computing device as recited in claim 37, wherein the computer-program instructions for analyzing are prior to receiving a request from the client computing device to fetch the document, the document being selected by the user from an annotated list of search results, the annotated list comprising one or more explicit hints for selection by the user to indicate the particular format.

50. A computing device as recited in claim 37, wherein the computer-program instructions for analyzing further comprise instructions for:
partitioning the document into multiple semantic blocks;
for each semantic block of the semantic blocks, extracting spatial features and content features;
for each semantic block of the semantic blocks, generating a respective feature vector from respective spatial and content features;
creating a semantic tree of the document from respective feature vectors generated from the semantic blocks, the semantic tree grouping related content in respective blocks of the multiple semantic blocks; and
and assigning a respective degree of coherence to node(s) of the semantic tree.

51. A computing device as recited in claim 50, wherein the spatial or content features comprise a location, a personal profile, a time of day, a schedule, or a browsing history.

52. A computing device as recited in claim 50, wherein the computer-program instructions for partitioning are implemented with a vision-based page segmentation algorithm.

53. A computing device as recited in claim 37, wherein the computer-program instructions for analyzing further comprise instructions for training a model to map block features to respective ones of the multiple importance values.

54. A computing device as recited in claim 37, wherein the computer-program instructions further comprise instructions for:
receiving search results from a search engine, the search results comprising a link associated with the document;
annotating the search results with one or more explicit hints for selection by a user to indicate any one format of the multiple formats, each format of the formats indicating a respective page layout for the one or more customized documents, portion(s) of the content being inserted or left out of the respective layout as a function block importance level(s) associated with the portion(s); and
communicating the annotated search results to a target client computing device.
